(19) United States
(12) Patent Application Publication
(10) Pub. No.: US 2024/0146808 A1
(43) Pub. Date: May 2, 2024

(54) SYSTEMS AND METHODS FOR PROVIDING MODULAR TELEMETRY AND CONTROL FOR SENSORS AND DEVICES

(71) Applicant: MICATU INC., Horseheads, NY (US)

(72) Inventors: Michael Oshetski, Horseheads, NY (US); Atul Pradhan, Pittsford, NY (US); James Kennedy, Corning, NY (US)

(21) Appl. No.: 18/474,850

(22) Filed: Sep. 26, 2023

Related U.S. Application Data
(60) Provisional application No. 63/381,458, filed on Oct. 28, 2022.

(51) Int. Cl. H04L 67/12; H04B 10/116

(52) U.S. Cl. CPC H04L 67/12; H04B 10/116

(57) ABSTRACT

A telemetry and control system for electrical grid sensors and devices includes modular telemetry and control units, each having module slots. Electro-optical modules are installable in the module slots, each having photodetectors and analog-to-digital converters. The electro-optical modules are adapted to receive an optical or electrical signal from a sensor or device installed in the electrical grid, and decode the optical or electrical signal to produce incoming data. The modular telemetry and control units are adapted to receive the incoming data from the electro-optical modules, apply a data model to the incoming data to produce telemetry data, and send the telemetry data to a remote computer system via a network.

### CROSS-REFERENCE TO RELATED APPLICATION(S)

This application claims priority to U.S. Provisional Patent Application No. 63/381,458, filed Oct. 28, 2022, the contents of which are incorporated herein by reference.

### TECHNICAL FIELD

The present disclosure relates to systems and methods for providing telemetry and control for sensors and devices in a remote location, such as an electrical grid, via a modular telemetry and control system.

### BACKGROUND

A number of technologies exist to monitor critical infrastructure such as electrical grids. Conventional systems include wire-based voltage and current sensors which rely on inductive and capacitive sensors for monitoring the level of voltage or current. The voltage and current sensors are coupled to associated data processing units that are required to convert the measured inductance and/or capacitance to the voltage or current values measured by the sensors. The sensors are connected to the associated data processing units via copper wires.

Such wire-based monitoring systems have a number of limitations. For example, wire-based systems suffer from issues of reliability and are not as accurate as newer sensors (typical accuracy is approximately +/−2%). Measurement accuracy of such systems can be affected by fluctuations in temperature. For example, signals transmitted long distances over copper wire may be degraded.

### SUMMARY

In one aspect, the disclosed embodiments provide a method for telemetry and control for electrical grid sensors and devices via a telemetry and control system comprising electro-optical modules installed in modular telemetry and control units. Each of the modular telemetry and control units includes a processor and memory in communication with the electro-optical modules installed therein. Each of the electro-optical modules includes one or more photodetectors and one or more analog-to-digital converters. The method includes receiving, by an electro-optical module, an optical or electrical signal from a sensor or device installed in the electrical grid, the electro-optical module being in communication with a modular telemetry and control unit. The method further includes decoding the optical or electrical signal to produce incoming data. The method further includes receiving, by the processor of the modular telemetry and control unit, the incoming data from the electro-optical module. The method further includes applying, by the processor of the modular telemetry and control unit, a first data model to the incoming data to produce telemetry data. The method further includes sending, by the processor of the modular telemetry and control unit, the telemetry data to a remote computer system via a network.

In another aspect, the disclosed embodiments provide a telemetry and control system for electrical grid sensors and devices. The system can include modular telemetry and control units, each comprising a processor and associated memory and having module slots. The system can include electro-optical modules installable in the module slots of the modular telemetry and control units to be in communication with the respective processors thereof. The electro-optical modules can include one or more photodetectors and one or more analog-to-digital converters. Photodetectors can be in communication with an analog-to-digital converter of the one or more analog-to-digital converters. The electro-optical modules can be adapted to: receive an optical or electrical signal from a sensor or device installed in the electrical grid, and decode the optical or electrical signal to produce incoming data. The respective processors of the modular telemetry and control units can be adapted to: receive the incoming data from the electro-optical modules, apply a first data model to the incoming data to produce telemetry data, and send the telemetry data to a remote computer system via a network.

In some embodiments, electro-optical modules can be installable within a housing of the modular telemetry and control unit so as to be connected to a bus of the modular telemetry and control unit. The housing of the modular telemetry and control unit can include a plurality of slots. The electro-optical modules can be in the form of cards adapted to be installed in the plurality of slots. The bus can include a backplane connecting the plurality of slots to the processor of the modular telemetry and control unit. The respective processors of the modular telemetry and control units are further adapted to receive the incoming data from the electro-optical modules via the bus.

In other embodiments, a modular telemetry and control unit can be positioned at a location of the sensor or device in an electrical grid.

In yet other embodiments, to decode an optical or electrical signal to produce incoming data, electro-optical modules can be adapted to use an analog-to-digital converter for an electrical signal, or a photodetector and the analog-to-digital converter for an optical signal.

In various embodiments, to apply a first data model, processors of a modular telemetry and control units can be adapted to extract data from, for example, formatted logs, stored data files, SCADA data structures, DNP points, and/or IEC 61850 data structures. A processor of a modular telemetry and control unit can be adapted to determine a first data model to interpret the incoming data. A processor of a modular telemetry and control unit can be adapted to transform telemetry data in accordance with a target database schema to apply a data model. A processor of a modular telemetry and control unit can be adapted to: receive, from the remote computer system via the network, a second data model based at least in part on an analysis of the telemetry data by the remote computer system; and/or apply the second data model to the incoming data to produce the telemetry data.

In some embodiments, electro-optical modules can include one or more light sources Electro-optical modules can be adapted to output an optical or electrical signal to a device installed in an electrical grid. Light sources can include one or more light emitting diodes (LEDs). Electro-optical modules can include digital-to-analog converters. Light sources can be in communication with a digital-to-analog converter, and, to output the optical or electrical signal to the device installed in the electrical grid, the electro-optical modules can be adapted to: (a) receive, from the respective processors of the modular telemetry and control units, outgoing data; and (b) encode the outgoing data to produce the optical or electrical signal. To encode outgoing data, electro-optical modules can be adapted to use a digital-to-analog converter for the electrical signal or the digital-to-analog converter and a light emitting diode (LED) for the optical signal.

In another aspect, the disclosed embodiments provide a telemetry and control system for sensors. The system can include a modular telemetry and control unit having a processor, associated memory, and a module slot. A sensor module can be installable in the module slot of the modular telemetry and control unit to be in communication with the processor. The sensor module can have a detector and/or an analog-to-digital converter. The detector can be in communication with the analog-to-digital converter. The sensor module can be adapted to receive a signal from the sensor and/or decode the signal to produce incoming data. The processor can be adapted to receive incoming data from a sensor module, apply a data model to incoming data to produce telemetry data, and/or send telemetry data to a remote computer system via a network. In some embodiments, a sensor module can be installable within a housing of a modular telemetry and control unit so as to be connected to a bus. A housing can include a plurality of slots. The sensor module can be a card adapted to be installed in at least one of the plurality of slots. The bus can include a backplane. The backplane can be configured to connect a plurality of slots to a processor of the modular telemetry and control unit. In various embodiments, a processor of a modular telemetry and control units can be adapted to receive incoming data from a sensor module via a bus. A processor can be adapted to extract data from, for example, formatted logs, stored data files, SCADA data structures, DNP points, and/or IEC 61850 data structures. A modular telemetry and control unit processor can be adapted to determine a data model to interpret the incoming data. A processor can be adapted to transform telemetry data in accordance with a target database schema. A processor can be further adapted to receive, from the remote computer system via the network, a second data model based at least in part on an analysis of the telemetry data by the remote computer system. A processor can be further adapted to apply a second data model to incoming data to produce telemetry data.

### BRIEF DESCRIPTION OF THE DRAWINGS

FIG. 1 depicts a system for telemetry and control system for electrical grid sensors and devices, according to disclosed embodiments;

FIG. 2 depicts a schematic view of modular telemetry and control unit, according to disclosed embodiments;

FIG. 3 depicts a schematic view of an electro-optical module, according to disclosed embodiments; and

FIG. 4 is a diagram of a method to provide telemetry and control for electrical grid sensors and devices via a telemetry and control system, according to disclosed embodiments.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. Moreover, the ordinarily skilled artisan will appreciate that while embodiments are discussed herein with regard to optical and electrical sensors for monitoring electrical grids, sensors of the embodiments can readily be substituted for other types of sensors (such as thermometers, strain gauges, radiation sensors, accelerometers, etc.) to receive similar and/or different types of signals to monitor various systems, such as industrial equipment, civil infrastructure, etc. without undue modification to the core of the embodiments and without undue experimentation. In some instances, well-known methods, procedures, components, and circuits have not been described in detail so as not to obscure the present invention.

Conventional data processing units used in monitor and control systems for electrical grids are typically limited to accepting analog, wireless, or optical sensor types and have specialized functionality that does not allow the system to be digitally reconfigured to emulate the behavior of other equipment, nor do they have modular design to accept multiple signal types that provide measurement values needed for conditioning monitoring of critical utility infrastructure.

Other grid monitoring technologies that address the problems with wire-based systems include wireless monitoring technologies. These wireless monitoring systems clamp onto power line cables and harvest energy for operation directly from the lines. Unlike the wire-based monitoring technologies, the wireless monitoring systems that monitor voltage and current do not send data via copper wires, but instead rely on wireless communications, such as cellular signals. The wireless sensors used in wireless condition monitoring for electrical grids also suffer from limitations in reliability. For example, wireless transmission requires that sensors incorporate electronics which are sensitive to electro-magnetic fields in an environment in which very strong electromagnetic fields are necessarily present, which can impact the overall reliability of such systems.

Optical sensors provide a number of advantages over wire-based and wireless monitoring systems. For example, optical sensors provide greater accuracy, better reliability, and easier methods for temperature compensation. Unlike wire-based and wireless technologies, optical sensors rely on analog optical telemetry for transmission of data. Analog optical telemetry offers a number of advantages relative to copper wires and wireless data transmission. For example, the optical signals do not suffer significant degradation of the signal when transmitted over long distances in the same manner as copper wire. Additional, optical systems do not require sensors to include electronics which are sensitive to electro-magnetic fields in an environment in which strong electromagnetic fields are necessarily present, such as in electrical grids. While analog telemetry offers advantages over other signal transmission methods, it may be impaired by poor connection quality.

Conventional types of data processing units for use in monitoring and controlling electrical grids typically have analog, wireless, or optical sensor types and have specialized functionality which does not allow the system to be easily reconfigured. Moreover, such systems do not have the capability to accept multiple signal types that provide measurement values needed for condition monitoring of critical utility infrastructure.

Disclosed embodiments provide a modular telemetry and control system that can collect data and send control signals to a wide variety of sensors and devices installed in the electrical grid. The system is interconnected via a cloud-based system and can interact with SCADA-based (supervisory control and data acquisition) systems.

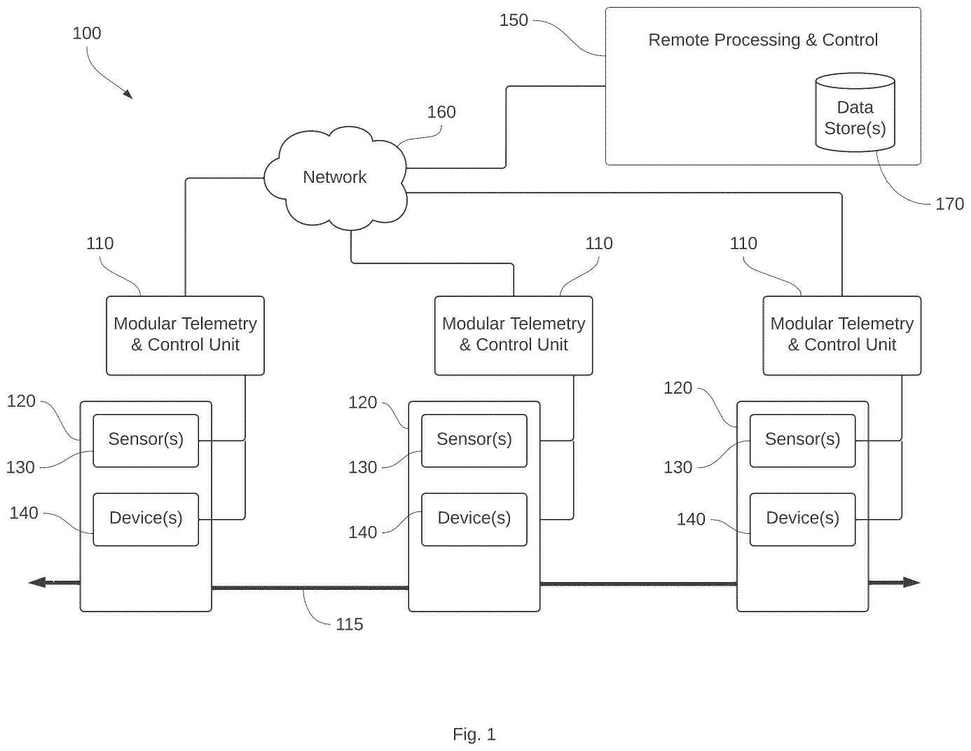

FIG. 1 depicts a system 100 for telemetry and control system for electrical grid sensors and devices. The system includes a number of modular telemetry and control (MTC) units 110 installed at locations in the electrical grid 115 near the equipment 120, e.g., the sensors 130 and devices 140, to be monitored and controlled. For example, an MTC unit 110 may be installed on a utility pole on which sensors 130 and/or other devices 140 are installed. The MTC units 110 may be in communication with a remote computer system 150 via a network 160, e.g., an Internet Protocol—based network. In embodiments, the remote computer system 150 may be a network or system having a cloud architecture, including one or more servers, and various other devices, e.g., database storage systems 170 and related devices.

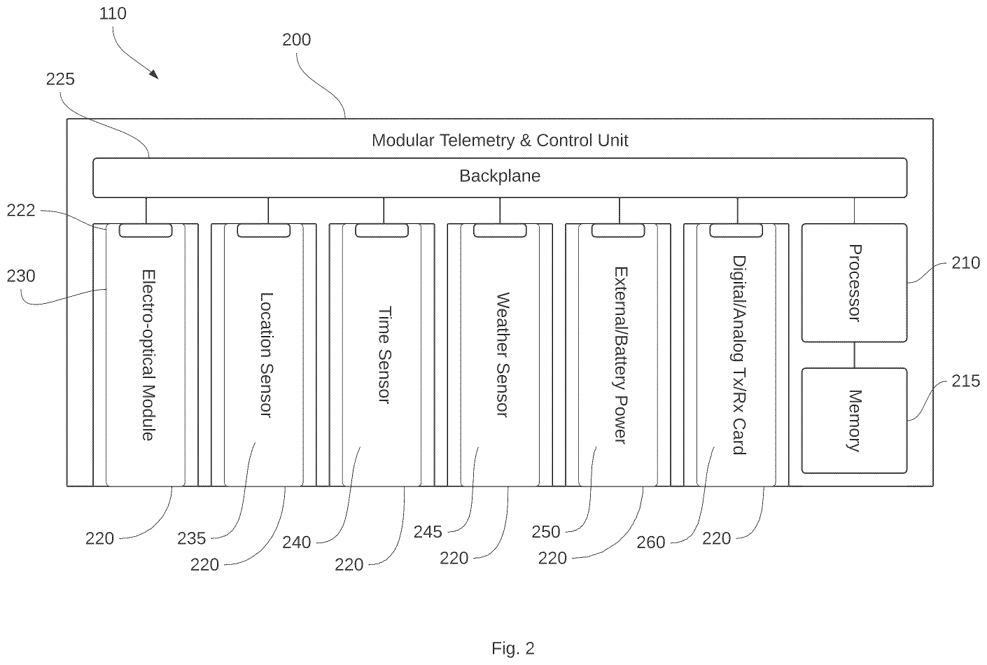

FIG. 2 depicts a schematic view of modular telemetry and control (MTC) unit 110. Each MTC unit 110 includes a housing 200 in which there is at least one processor 210, with associated memory 215, and a number of module slots 220. In embodiments, the housing may be a full-size rack housing (i.e., 19″ wide). Electro-optical modules 230, which are discussed in further detail below, are installable in the module slots 220 of the modular telemetry and control units 110 so as to be in communication with the respective processors 210 of the MTC units 110 via a bus, e.g., a backplane 225, in the housing 200. As further discussed below, various other types of modules may be installed in the module slots 220, so that the MTC unit 110 may perform a wide array of telemetry and control functions in a variety of system environments.

In embodiments, in addition to, or in lieu of, the electro-optical modules 230 discussed above, individual modules may be used for specific types of measurements, such as an optical voltage sensor (not shown), optical current sensor (not shown), electrical voltage sensor (not shown), and electrical current sensor (not shown). As noted above, the target datastore may be adapted to store contextual data which is related to the telemetry data received from the MTC units 110, such as weather data, electrical grid usage, usage history, and status information, equipment installation and maintenance information, etc. Various types of modules adapted to receive and/or output such data may be installed in the MTC unit 110, such as location sensors 235 (e.g., Global Positioning System), time sensors 240, and weather sensors 245. Other types of modules may be installed to provide specific functionalities useful in operating the MTC unit 110, such as an external/battery power module 250 which can receive an external power input and/or provide battery power, e.g., a chargeable battery. A communication card may be installed, such as a digital/analog transmit (Tx) and receive (Rx) card 260, which may provide various types of wired and/or wireless data communication, e.g., ethernet, fiber optic data network, and/or cellular network communications. The various installed modules may be connected via the backplane 225 to the processor and memory of the MTC unit 110.

In embodiments, the electro-optical modules 230 may be cards, e.g., peripheral component interconnect (PCI) cards, each of which may be inserted into a slot 220 so that a connector 222 on the edge of the electro-optical module 230 connects with the backplane 225. In embodiments, the backplane 225 may be positioned on an internal back wall or a bottom internal surface of the MTC unit 110. By virtue of these features, the electro-optical modules can be “hot swapped,” i.e., installed and uninstalled while the system is in operation.

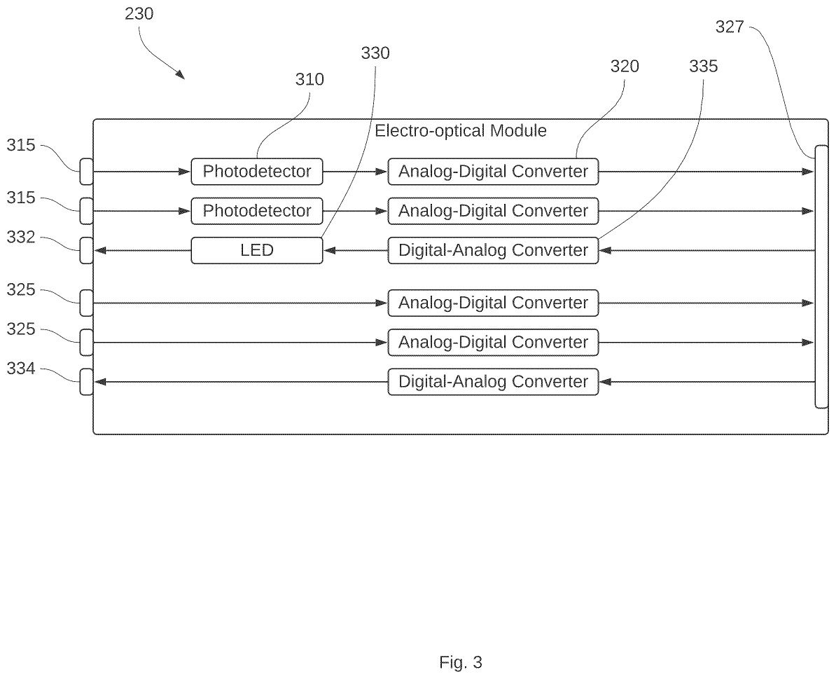

FIG. 3 depicts a schematic view of an electro-optical module 230. Each of the electro-optical modules 230 includes one or more photodetectors 310, which are adapted to receive an analog optical signal from an optical input 315 of the electro-optical module 230 and convert it into an analog electrical signal. The electro-optical modules 230 further include one or more analog-to-digital converters 320, which are adapted to convert an analog electrical signal output by the photodetectors 310 into a digital electrical signal for further processing. In embodiments, each of the photodetectors 310 is in communication with a corresponding analog-to-digital converter 320. In embodiments, some of the analog-to-digital converters 320 are adapted to receive an analog electrical signal from an electrical input 325 of the electro-optical module 230.

Thus, the electro-optical modules 230 receive optical or electrical signals via an optical input 315 or an electrical input 325, respectively, from sensors 130 and devices 140 (see FIG. 1) installed in the electrical grid and decode the optical or electrical signals to produce incoming data. The incoming data may include, for example, sensor measurements, status signals, control signals, etc., to be processed by the MTC units 110. The MTC units 110 receive the incoming data from the electro-optical modules 230 (e.g., via a backplane connector 327 of the electro-optical module 230), and, as discussed in further detail below, apply a data model to the incoming data to produce telemetry data. The telemetry data may be sent to a remote computer system via a network, e.g., a cloud-based distributed architecture computer system.

In embodiments, each of the electro-optical modules 230 may include one or more light sources, e.g., light emitting diodes (LEDs) 330, and may be adapted to output an optical or electrical signal to a device 140 (see FIG. 1) installed in the electrical grid 115 via an optical output 332 or an electrical output 334, respectively. The electro-optical modules 230 may further include one or more digital-to-analog converters 335, with each of the LEDs 330 being in communication with a digital-to-analog converter 335. To output the optical or electrical signal to a device 140 installed in the electrical grid, the electro-optical module 230 may be adapted to receive outgoing data from the processor 210 of the MTC unit 110 (e.g., via a backplane connector 327 of the electro-optical module 230) and further adapted to encode the outgoing data to produce the optical or electrical signal. To encode the outgoing data, the electro-optical modules 230 may be adapted to use a digital-to-analog converter 335 for the electrical signal or the digital-to-analog converter 335 and an LED 330 for the optical signal.

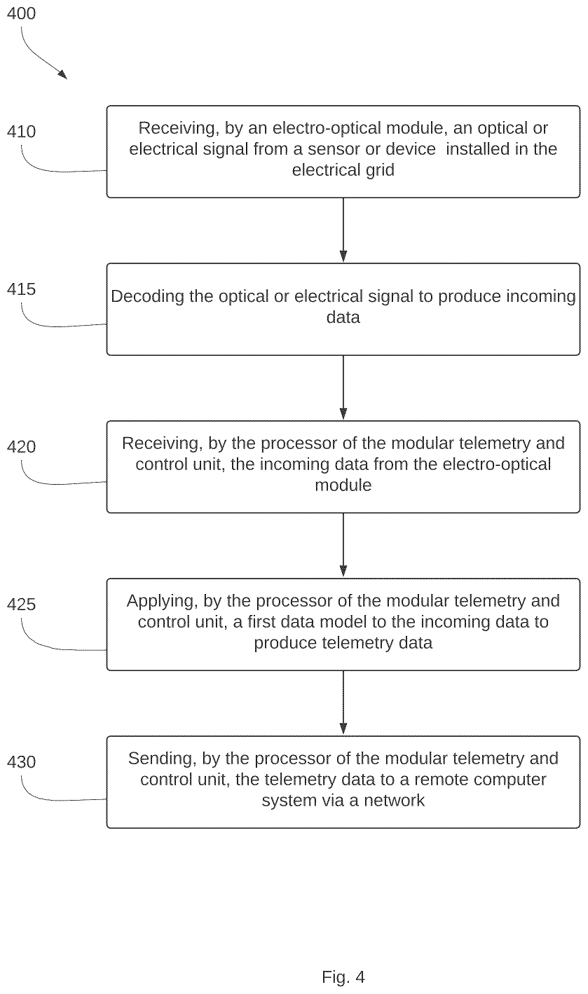

FIG. 4 is a diagram of a method 400 to provide telemetry and control for electrical grid sensors 130 and devices 140 via a telemetry and control system 100. As explained above, the system 100 includes electro-optical modules 230 installed in modular telemetry and control (MTC) units 110 (see FIGS. 1 and 2). Each of the electro-optical modules 230 includes one or more photodetectors 310 (see FIG. 3) and one or more analog-to-digital converters 320.

The method 400 includes receiving (410), by an electro-optical module 230, an optical or electrical signal from a sensor 130 or device 140 installed in the electrical grid 115. The method 400 further includes decoding (415) the optical or electrical signal to produce incoming data. The method 400 further includes receiving (420), by the processor 210 of the modular telemetry and control (MTC) unit 110, the incoming data from the electro-optical module 230. The method 400 further includes applying (425), by the processor 210 of the MTC unit 110, a first data model to the incoming data to produce telemetry data. The method 400 further includes sending (430), by the processor 210 of the MTC unit 110, the telemetry data to a remote computer system 150 via a network 160.

In embodiments, the applying (425) of the first data model to the incoming data to produce telemetry data may include extracting data from formatted logs, stored data files, supervisory control and data acquisition (SCADA) data structures, distributed network protocol (DNP) points, and/or IEC 61850 data structures. The applying (425) of the first data model may include converting the extracted data into elements formatted to populate a database. For example, the database elements may be formatted in Structured Query Language (SQL). In embodiments, the applying (425) of the first data model further includes processing the extracted data into sub-units, i.e., elements, of a structured database, e.g., an SQL database. In embodiments, the applying (425) of the first data model may include transforming the telemetry data in accordance with a defined target database schema.

In embodiments, the applying (425) of the first data model may include applying one or more extract, transform, and load (ETL) tools to transform the telemetry data in accordance with a target database schema. This may include using ETL tools to validate, authenticate, deduplicate, and/or aggregate the data to ensure that it is reliable and usable in the context of a datastore. For example, data aggregation may be used in the receiving of data by the processor 210 of an MTC unit 110 from multiple electro-optical modules 230 installed therein.

In some cases, the data model used to interpret the incoming data may be, for example, a semantic hierarchical object data model according to IEC 61850, which is used to describe the data points associated with a product device at substations and power generation and transmission centers. In such a case, the sensors 130 and/or other devices 140 installed in the electrical grid (see FIG. 1), which may be referred to as intelligent electronic devices (IED), may be divided into logical devices, logical nodes and data objects. An IED may have logical devices for particular applications, with each logical device including a group of logical nodes or functions, which include any necessary data objects. According to IEC 61850, data for an IED has the format of Logical Device.Logic Node.Data Object.Attribute. For example, incoming data from a sensor measuring phase A load current may have the form: LD0.CMMXU1.A.phsA. cVal.mag.f, where “cVal.mag.f” is an attribute used for magnitude measurement. The class designation structure of IEC 61850 for data points can be mapped into an object-oriented software system design for definition of the template of data objects. Each object is an instantiation of the class, with IEC 61850 defining standard common classes. This allows use of an algorithm, procedure, or method that converts the class designation structure of IEC 61850 for an IED on the grid into an object-oriented class in a procedure-based software language, such as Structured Query Language (SQL).

In embodiments, the MTC unit 110 may determine the first data model to interpret the incoming data by, for example, selecting a data model from a set of data models based on analysis of the incoming data. For example, the syntax of the incoming data may be analyzed and/or compared to known data models. In embodiments, the data model may be determined based on one or more parameters set by a user. For example, the user may set parameters for a known piece of equipment or sensor specifying a particular data model. In embodiments, the data model may be based on a CID (configuration IED description) file, as defined in IEC 61850, which includes all logic devices, logic nodes, and data objects for a particular IED.

In embodiments, the applying (425) of the first data model and/or the sending (430) of the telemetry data to the remote computer system 150 may include performing operations on the telemetry data in a distributed grid with edge computing core sub-units comprising aggregations of the MTC units 110. This may include performing operations on the telemetry data, wherein the operations are virtualized and provisioned on a distributed grid architecture of the modular telemetry and control units. In some cases, the telemetry data in the distributed grid architecture (which may be concurrently available, e.g., to be used for real-time or in situ calculations) may be used to generate dashboards, plots, and/or displays of the distributed grid status and conditions. The telemetry data may be used, for example, to assess voltage, current, temperature, power factor, load, and related measurements, of an electrical power generation utility grid.

In embodiments, the sending (430), by the MTC unit 110, of the telemetry data to the remote computer system 150 may include distributing the telemetry data in the remote computer system 150, which may be a network or system having a cloud architecture, including one or more servers, and various other devices, e.g., database storage systems 170 and related devices.

In embodiments, ETL tools may be used both in the applying (425) of the first data model and in the sending (430) of the telemetry data to the remote computer system (150). For example, extraction tools may be used in the identification and receiving of data by the processor 210 of an MTC unit 110 from multiple electro-optical modules 230 installed therein, so that the data can be transported and stored in the target datastore. Extraction tools may also be used in the identification and receiving of data by the remote computer system (150) from multiple sources, e.g., multiple MTC units 110. In such a case, the data received by the remote computer system (150), i.e., the telemetry data sent by the MTC units 110, may be in various formats and may be the product of different data models. In embodiments, the telemetry data may be combined with data from a variety of structured and unstructured sources, including documents, emails, business applications, databases, equipment, sensors, third parties, etc. By virtue of this arrangement, the target datastore can be adapted to store contextual data which is related to the telemetry data received from the MTC units 110, such as weather data, electrical grid usage, usage history, and status information, equipment installation and maintenance information, etc.

In embodiments, the method 400 may include receiving, from the remote computer system 150 via the network 160, a second data model based at least in part on an analysis of the telemetry data by the remote computer system 150. The second data model may be applied, by the processor 210 of the MTC unit 110, to the incoming data to produce the telemetry data. The second data model may provide improved performance relative to the first data model, because the second data model is generated by the remote computer system 150, which has access to incoming data from a number of MTC units 110. In addition, the remote computer system 150 may have greater processing capability and may have access to large data stores which may be used to develop and/or improve algorithms for determining a data model.

The method 400 may further include sending, by the MTC unit 110, to the remote computer system 150 via the network 160, parameters characterizing the first data model. In such a case, the second data model may be based at least in part on an analysis by the remote computer system 150 of the telemetry data and the parameters characterizing the first data model.

In embodiments, the method 400 may further include outputting, by the electro-optical module 230, an optical or electrical signal to a device 140 installed in the electrical grid 115. For example, the electro-optical module 230 may output digital electrical signals to drive relays in electrical grid switching equipment. This may include receiving, by the processor 210 of the MTC unit 110, control data from a remote computer system 150 via a network 160. This may further include determining, by the processor 210 of the MTC unit 110, a third data model to interpret the control data. In such a case, the processor 210 of the MTC unit 110 may apply the third data model to the control data to produce the outgoing data. In embodiments, the third data model may be a standardized control format, such as SCADA.

Embodiments are discussed herein primarily in regard to utility grid monitoring by remote sensors collecting data, algorithms processing such data into a useful format, and storing it in a database. The framework, as a skilled artisan would appreciate from the foregoing, can be adapted for various other applications beyond monitoring electrical grids. The invention has broad applicability to areas such as industrial equipment monitoring, environmental monitoring, structural health monitoring of buildings and/or bridges, agricultural, healthcare, energy management, chain supply, seismic activity, traffic and transportation, weather, retail and/or customer behavior, and other areas where remote monitoring can be deployed.

For example, replacing electrical sensors with vibration, temperature, and/or acoustic sensors can allow for monitoring the health of machinery. This is crucial for predictive maintenance, where data can be analyzed to predict when a machine might fail and thus needs maintenance. The systems and methods can be adapted to monitor environmental parameters such as air quality, water quality, and radiation levels. For example, remote sensors can be deployed in various locations to measure pollutant levels in air or water, and algorithms described herein can process such data to identify trends and/or areas of concern. Replacing electrical sensors with strain gauges, accelerometers, and/or other types of sensors can be done to monitor the health of civil infrastructure. This can be critical for early detection of structural problems that could lead to catastrophic failure if not addressed. Sensors can monitor the conditions of goods during transport (e.g., temperature, humidity, shock/vibration). Seismometers and/or accelerometers can be utilized to monitor earthquake and/or tsunami activity. The data collected can be used for early warning systems and/or for scientific research. Using cameras or other sensors, embodiments can monitor customer movements and behavior in a retail space, which can help to optimize store layout and marketing strategies.

For each of these applications, the type of sensors used and the algorithms for processing the sensor data would need to be adapted to suit the specific needs and constraints of the field. However, the underlying concept of embodiments disclosed and described herein—remote data collection, algorithmic processing, and centralized data storage and analysis—is highly versatile and can be a strong foundation for various applications.

Aspects of the present invention may be embodied in the form of a system, a computer program product, or a method. Similarly, aspects of the present invention may be embodied as hardware, software, or a combination of both. Aspects of the present invention may be embodied as a computer program product saved on one or more computer-readable media in the form of computer-readable program code embodied thereon.

A computer-readable medium may be a computer-readable storage medium. A computer-readable storage medium may be, for example, an electronic, optical, magnetic, electromagnetic, infrared, or semiconductor system, apparatus, or device, or any combination thereof.

Computer program code in embodiments of the present invention may be written in any suitable programming language. The program code may execute on a single computer, or on a plurality of computers. The computer may include a processing unit in communication with a computer-usable medium, where the computer-usable medium contains a set of instructions, and where the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A telemetry and control system for electrical grid sensors and devices, the system comprising:
modular telemetry and control units, each comprising a processor and associated memory and having module slots;
electro-optical modules installable in the module slots of the modular telemetry and control units to be in communication with the respective processors thereof, each of the electro-optical modules comprising one or more photodetectors and one or more analog-to-digital converters, each of said one or more photodetectors being in communication with an analog-to-digital converter of said one or more analog-to-digital converters, the electro-optical modules being adapted to:
receive an optical or electrical signal from a sensor or device installed in the electrical grid, and
decode the optical or electrical signal to produce incoming data,
wherein the respective processors of the modular telemetry and control units are adapted to:
receive the incoming data from the electro-optical modules,
apply a first data model to the incoming data to produce telemetry data, and
send the telemetry data to a remote computer system via a network.

2. The system of claim 1, wherein each electro-optical module is installable within a housing of the modular telemetry and control unit so as to be connected to a bus of the modular telemetry and control unit.

3. The system of claim 2, wherein the housing of the modular telemetry and control unit comprises a plurality of slots and the electro-optical modules are in the form of cards adapted to be installed in said plurality of slots, and wherein the bus comprises a backplane connecting said plurality of slots to the processor of the modular telemetry and control unit.

4. The system of claim 2, wherein the respective processors of the modular telemetry and control units are further adapted to receive the incoming data from the electro-optical modules via the bus.

5. The system of claim 1, wherein the modular telemetry and control unit is positioned at a location of the sensor or device in the electrical grid.

6. The system of claim 1, wherein, to decode the optical or electrical signal to produce incoming data, the electro-optical modules are further adapted to use an analog-to-digital converter for the electrical signal, or a photodetector and the analog-to-digital converter for the optical signal.

7. The system of claim 1, wherein, to apply the first data model, the respective processors of the modular telemetry and control units are further adapted to extract data from one or more of the following: formatted logs, stored data files, SCADA data structures, DNP points, and IEC 61850 data structures.

8. The system of claim 1, wherein the respective processors of the modular telemetry and control units are further adapted to determine the first data model to interpret the incoming data.

9. The system of claim 1, wherein, to apply the first data model, the respective processors of the modular telemetry and control units are further adapted to transform the telemetry data in accordance with a target database schema.

10. The system of claim 1, wherein the respective processors of the modular telemetry and control units are further adapted to: (a) receive, from the remote computer system via the network, a second data model based at least in part on an analysis of the telemetry data by the remote computer system; and (b) apply the second data model to the incoming data to produce the telemetry data.

11. The system of claim 1, wherein each of the electro-optical modules further comprises one or more light sources, and the electro-optical modules are further adapted to output an optical or electrical signal to a device installed in the electrical grid.

12. The system of claim 11, wherein said one or more light sources comprise one or more light emitting diodes (LEDs).

13. The system of claim 11, wherein each of the electro-optical modules further comprises one or more digital-to-analog converters, each of said one or more light sources being in communication with a digital-to-analog converter of said one or more digital-to-analog converters, and, to output the optical or electrical signal to the device installed in the electrical grid, the electro-optical modules are further adapted to: (a) receive, from the respective processors of the modular telemetry and control units, outgoing data; and (b) encode the outgoing data to produce the optical or electrical signal.

14. The system of claim 13, wherein, to encode the outgoing data, the electro-optical modules are adapted to use a digital-to-analog converter for the electrical signal or the digital-to-analog converter and a light emitting diode (LED) for the optical signal.

15. A method to provide telemetry and control for electrical grid sensors and devices via a telemetry and control system comprising electro-optical modules installed in modular telemetry and control units, each of the modular telemetry and control units comprising a processor and memory in communication with the electro-optical modules installed therein, each of the electro-optical modules comprising one or more photodetectors and one or more analog-to-digital converters, the method comprising:
receiving, by an electro-optical module, an optical or electrical signal from a sensor or device installed in the electrical grid, the electro-optical module being in communication with a modular telemetry and control unit;
decoding the optical or electrical signal to produce incoming data;
receiving, by the processor of the modular telemetry and control unit, the incoming data from the electro-optical module;
applying, by the processor of the modular telemetry and control unit, a first data model to the incoming data to produce telemetry data;
sending, by the processor of the modular telemetry and control unit, the telemetry data to a remote computer system via a network.

16. The method of claim 15, wherein the electro-optical module is installed within a housing of the modular telemetry and control unit and is connected to a bus of the modular telemetry and control unit.

17. The method of claim 16, wherein the housing of the modular telemetry and control unit comprises a plurality of slots and the electro-optical module is in the form of a card adapted to be installed in one of said plurality of slots, and wherein the bus comprises a backplane connecting said plurality of slots to the processor of the modular telemetry and control unit.

18. The method of claim 16, wherein said receiving, by the processor of the modular telemetry and control unit, the incoming data from the electro-optical module comprises receiving the incoming data from the electro-optical module via the bus.

19. The method of claim 15, wherein the modular telemetry and control unit is positioned at a location of the sensor or device in the electrical grid.

20. The method of claim 15, wherein said decoding uses an analog-to-digital converter for the electrical signal, or a photodetector and the analog-to-digital converter for the optical signal.

21. The method of claim 15, wherein said applying the first data model comprises extracting data from one or more of the following: formatted logs, stored data files, SCADA data structures, DNP points, and IEC 61850 data structures.

22. The method of claim 21, wherein said applying the first data model further comprises converting the extracted data into elements formatted to populate a database.

23. The method of claim 22, wherein the database elements are formatted in Structured Query Language (SQL).

24. The method of claim 22, wherein said applying the first data model further comprises processing the extracted data into sub-units of a structured database.

25. The method of claim 12, wherein the structured database is a Structured Query Language (SQL) database.

26. The method of claim 15, further comprising determining, by the processor of the modular telemetry and control unit, the first data model to interpret the incoming data.

27. The method of claim 26, wherein the first data model to interpret the incoming data comprises a semantic hierarchical data model according to IEC 61850.

28. The method of claim 15, wherein said applying the first data model comprises transforming the telemetry data in accordance with a target database schema.

29. The method of claim 15, further comprising:
receiving, by the processor of the modular telemetry and control unit, from the remote computer system via the network, a second data model based at least in part on an analysis of the telemetry data by the remote computer system; and
applying, by the processor of the modular telemetry and control unit, the second data model to the incoming data to produce the telemetry data.

30. The method of claim 29, further comprising: sending, by the processor of the modular telemetry and control unit, to the remote computer system via the network, parameters characterizing the first data model, wherein the second data model is based at least in part on an analysis by the remote computer system of the telemetry data and the parameters characterizing the first data model.

31. The method of claim 15, wherein the electro-optical module further comprises one or more light sources, the method further comprising outputting, by the electro-optical module, an optical or electrical signal to a device installed in the electrical grid.

32. The method of claim 31, wherein said one or more light sources comprise one or more light emitting diodes (LEDs).

33. The method of claim 31, wherein the electro-optical module further comprises one or more digital-to-analog converters, and said outputting, by the electro-optical module, the optical or electrical signal to the device installed in the electrical grid comprises: sending, by the processor of the modular telemetry and control unit, outgoing data to the electro-optical module; and encoding the outgoing data to produce the optical or electrical signal.

34. The method of claim 33, wherein said encoding uses a digital-to-analog converter for the electrical signal or the digital-to-analog converter and a light emitting diode (LED) for the optical signal.

35. The method of claim 33, further comprising:
receiving, by the processor of the modular telemetry and control unit, control data from a remote computer system via a network;
determining, by the processor of the modular telemetry and control unit, a third data model to interpret the control data; and
applying, by the processor of the modular telemetry and control unit, the third data model to the control data to produce the outgoing data.

36. A telemetry and control system for sensors, comprising:
a processor communicatively coupled to a memory;
a sensor having a detector;
an analog-to-digital converter, the detector communicatively coupled to the analog-to-digital converter, the sensor adapted to receive a signal from the analog-to-digital converter and decode the signal to produce incoming data,
wherein the processor is adapted to receive the incoming data, apply a data model to the incoming data to produce telemetry data, and send the telemetry data to a remote computer system via a network.

37. A telemetry and control system for sensors, comprising:
a modular telemetry and control unit having a processor, associated memory, and a module slot;
a sensor module installable in the module slot of the modular telemetry and control unit to be in communication with the processor, the sensor module having a detector and an analog-to-digital converter, the detector being in communication with the analog-to-digital converter, the sensor module adapted to receive a signal from the sensor and decode the signal to produce incoming data,
wherein the processor of the modular telemetry and control unit is adapted to:
receive the incoming data from the sensor module, apply a data model to the incoming data to produce telemetry data, and send the telemetry data to a remote computer system via a network.

38. The system of claim 37, wherein the sensor module is installable within a housing of the modular telemetry and control unit so as to be connected to a bus of the modular telemetry and control unit.

39. The system of claim 38, wherein the housing of the modular telemetry and control unit comprises a plurality of slots and the sensor module is in the form of a card adapted to be installed in at least one of said plurality of slots, and wherein the bus comprises a backplane connecting said plurality of slots to the processor of the modular telemetry and control unit.

40. The system of claim 38, wherein the processor of the modular telemetry and control units is further adapted to receive the incoming data from the sensor module via the bus.

41. The system of claim 37, wherein the processor of the modular telemetry and control unit is further adapted to extract data from one or more of: formatted logs, stored data files, SCADA data structures, DNP points, and IEC 61850 data structures.

42. The system of claim 37, wherein the processor of the modular telemetry and control unit is further adapted to determine the data model to interpret the incoming data.

43. The system of claim 37, wherein the processor of the modular telemetry and control unit is further adapted to transform the telemetry data in accordance with a target database schema.

44. The system of claim 37, wherein the processor of the modular telemetry and control unit is further adapted to: receive, from the remote computer system via the network, a second data model based at least in part on an analysis of the telemetry data by the remote computer system; and apply the second data model to the incoming data to produce the telemetry data.

45. A method to provide telemetry and control for sensors and devices via a telemetry and control system, comprising sensor modules installed in modular telemetry and control units, each of the modular telemetry and control units comprising a processor and memory in communication with the sensor modules installed therein, each of the sensor modules comprising one or more signal detectors and one or more converters, the method comprising:
receiving, by a sensor module, a signal from a sensor or device, the sensor module being in communication with a modular telemetry and control unit;
decoding the signal to produce incoming data;
receiving, by the processor of the modular telemetry and control unit, the incoming data from the sensor module;
applying, by the processor of the modular telemetry and control unit, a data model to the incoming data to produce telemetry data;
sending, by the processor of the modular telemetry and control unit, the telemetry data to a remote computer system via a network.
